(19) United States
(12) Patent Application Publication
(10) Pub. No.: US 2012/0137148 A1
(43) Pub. Date: May 31, 2012

(54) RACK SERVER DEVICE

(75) Inventors: Jian-Hua HE, SHANGHAI (CN); Shen-Hsien LIU, TAIPEI CITY (TW)

(73) Assignee: INVENTEC CORPORATION, TAIPEI CITY (TW)

(21) Appl. No.: 13/032,617

(22) Filed: Feb. 22, 2011

(30) Foreign Application Priority Data
Nov. 30, 2010 (CN) 201010575169.1

(51) Int. Cl. G06F 1/26

(52) U.S. Cl. 713/310

(57) ABSTRACT

A rack server device includes a plurality of servers and at least one control board of rack server device. Each of the servers includes a baseboard management controller (BMC). The BMC is operable to receive a power-on controlling signal so that the BMC can turn on the server. The control board of rack server device is connected to the servers through a management network and outputs the power-on controlling signal based on an input command. The control board of rack server device outputs the power-on controlling signal to the BMC of one of the servers so that the BMC turns on the server.

### RELATED APPLICATIONS

This application claims priority to China Application Serial Number 201010575169.1, filed Nov. 30, 2010, which is herein incorporated by reference.

### BACKGROUND

1. Field of Invention

The present invention relates to a server device, more particularly, to a rack server device which has a mechanism for controlling a turn-on sequence of the servers.

2. Description of Related Art

Cloud computing is a new computing method through the Internet, which provides on-demand computing for individuals and enterprise users through heterogeneous and autonomous services through the Internet. As the resources are placed on the Internet, and in the computer flow chart, generally the Internet is represented by a cloud pattern, the computing can be vividly analogized as the cloud computing. Moreover, the cloud is also an abstract concept of the infrastructure.

In the cloud computing, a dynamic expandable function and virtualized resources are provided through the Internet, such that a terminal user does not need to know the details of the infrastructure in the cloud computing, have the relevant professional knowledge or perform direct controls. The user only needs to focus on the resources that are really needed and the way to get the related services over the network.

To meet the large data storage and processing amount, a more complete infrastructure is expected, in which a large-scale rack server is crucial for the cloud computing. However, due to the large-scale rack server generally contains sixty to seventy servers therein, if all the servers are turned on at the same time and all modules within each of the servers is initialized, it will cause a large power consumption and current rush. In addition, the overlapped power consumption peak values and current peaks will cause a large load on the power system.

Therefore, the rack server needs further improvements.

### SUMMARY

An aspect of the present invention is to provide a rack server device, thereby alleviating the problem of large power consumption and current rush caused by turning on the servers in the rack server device at the same time and moderating the load on the power system.

To achieve the above aspect, a technical aspect of the present invention relates to a rack server device which includes a plurality of servers and at least one control board of rack server device. Each of the servers includes a baseboard management controller. The baseboard management controller is operable to receive a power-on controlling signal so that the baseboard management controller can turn on the server. The control board of rack server device is connected to the servers through a management network and outputs the power-on controlling signal based on an input command.

Furthermore, the control board of rack server device outputs the power-on controlling signal to the BMC of one of the servers, so that the baseboard management controller turns on the server.

In one embodiment of the present invention, a power restore state of a basic input/output system of each of the servers is set to be always OFF.

In another embodiment of the present invention, after the control board of rack server device outputs the power-on controlling signal to the server for a predetermined period, the control board of rack server device outputs the power-on controlling signal to another server so as to realize the random power on of each of the servers.

In yet another embodiment of the present invention, the rack server device further includes a switch that is operable to provide the management network.

In still another embodiment of the present invention, the input command is an intelligent platform management interface (IPMI) command.

In a further embodiment of the present invention, the rack server device further includes a user interface that is electrically connected to the control board of rack server device, and the input command is generated by the user interface.

In yet a further embodiment of the present invention, the user interface generates the input command so that the control board of rack server device sequentially outputs the power-on controlling signal to the servers respectively based on the input command, such that the servers are sequentially turned on.

In still another embodiment of the present invention, the control board of rack server device includes a storage element that is operable to store the command sequence, and the command sequence is operable to provide the input command.

In yet another embodiment of the present invention, the command sequence provide the input command so that the control board of rack server device sequentially outputs the power-on controlling signal to the servers respectively based on the input command, such that the servers are sequentially turned on.

In still another embodiment of the present invention, the command sequence is composed of intelligent platform management interface commands.

In still a further embodiment of the present invention, the control board of rack server device extracts a media access control address or a rack management address of the baseboard management controller of the servers and randomly generates a plurality of delay periods according to the media access control address or the rack management address so that the baseboard management controller of the servers sequentially turns on the servers according to the delay periods.

Therefore, according to the technical content of the present invention, the present invention provides a rack server device, thereby alleviating the problem of large power consumption and current rush caused by turning on the servers in the rack server device at the same time and moderating the load on the power system.

### BRIEF DESCRIPTION OF THE DRAWINGS

In order to make the following as well as other aspects, features, advantages, and embodiments of the present invention more apparent, the accompanying drawings are described as follows:

FIG. 1 is a schematic view of a rack server device according to one embodiment of the present invention.

### DETAILED DESCRIPTION

The present invention will be described in the following embodiments with reference to the accompanying drawing, but these embodiments are not intended to limit the present invention. The description of structure operation does not mean to limit its implementation order. Any device with equivalent functions that is produced from a structure formed by recombination of elements shall fall within the scope of the present invention. The drawings are only illustrative and are not made according to the original size.

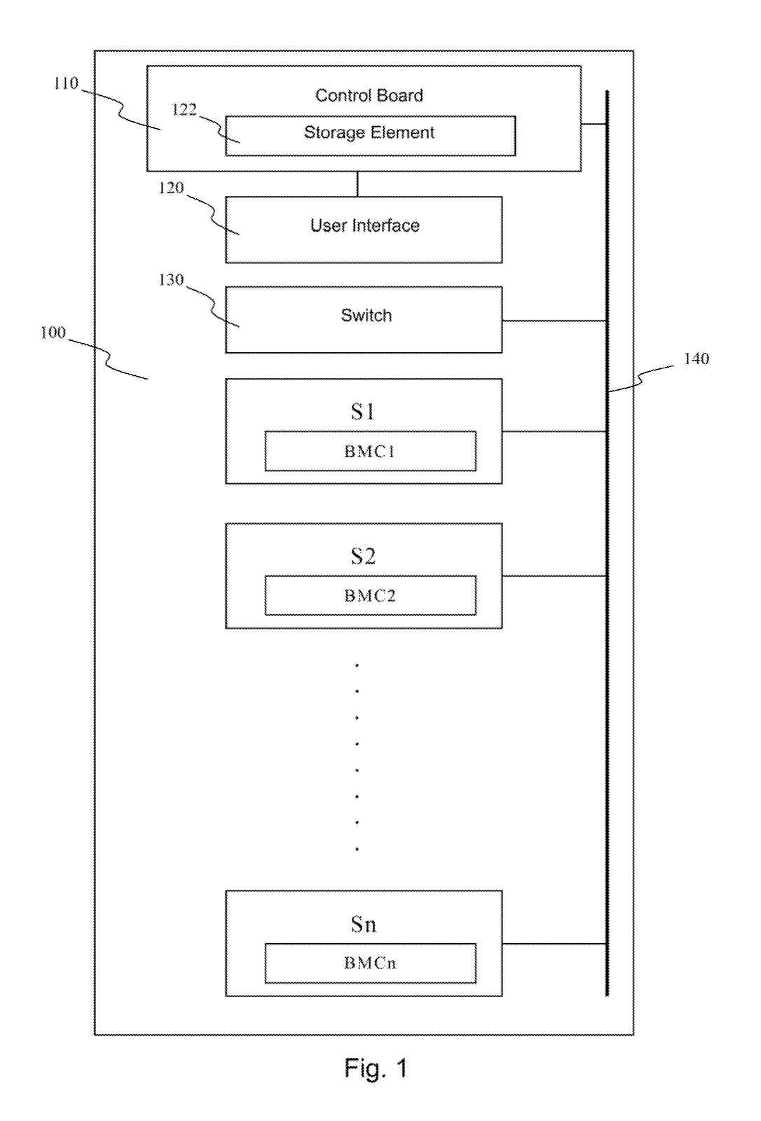

FIG. 1 is a schematic view of a rack server device 100 according to one embodiment of the present invention. The rack server device 100 includes a control board 110 of rack server device, a user interface 120, a switch 130 and a plurality of servers S1-Sn.

Each of the servers S1-Sn includes a corresponding baseboard management controller (BMC), for example the server S1 includes a baseboard management controller BMC1, the server S2 includes a baseboard management controller BMC2, . . . , and the server Sn includes a baseboard management controller BMCn.

The rack server device 100 may include at least one control board 110 of rack server device. In an optional embodiment, a user can arrange the number of the control boards 110 of rack server device required for the operation of the rack server device 100 in the rack server device 100 according to the practical control requirements. The descriptions below illustrate the actuation manner of only a single control board 110 of rack server device in the rack server device 100.

It should be explained firstly that, in the rack server device 100 according to the embodiment of the present invention, a power restore state of each of the servers S1-Sn needs to be set so that the power restore policy is always OFF in the basic input/output system (BIOS). That is to say, when the power of the servers S1-Sn are turned on, the servers S1-Sn remain in a shut down state and are not turned on until the servers S1-Sn receive a power-on controlling signal that is described below.

As shown in FIG. 1, the switch 130 provides a management network 140. In this manner, the control board 110 of rack server device can be connected to the servers S1-Sn through the management network 140. In addition, the control board 110 of rack server device outputs the power-on controlling signal to the selected server based on an input command.

For example, the input command may include information of outputting the power-on controlling signal to the server S2, then the control board 110 of rack server device outputs the power-on controlling signal to the server S2 based on the input command. After that, when the baseboard management controller BMC2 of the server S2 receives the power-on controlling signal, the baseboard management controller BMC2 turns on the server S2.

In this embodiment, the above input command is an intelligent platform management interface (IPMI) command. Referring to FIG. 1, in one embodiment, the user interface 120 is electrically connected to the control board 110 of rack server device, and the input command may be generated by the user interface 120 and is output to the control board 110 of rack server device.

In operation, the user can use the user interface 120 to input and then the user interface 120 generates the input command. The user can use the user interface 120 to input the input command according to the practical requirements. For example, when the user wants the servers S1-Sn to be turned on one by with a certain sequence, the user can use the user interface 120 to input the input command with the certain sequence. Then, the user interface 120 may sequentially generates the input command to the control board 110 of rack server device respectively, and the control board 110 of rack server device may sequentially output the power-on controlling signal to the servers S1-Sn respectively based on the input command, such that the servers S1-Sn are sequentially turned on. In this manner, the user may input the turn on sequence of the servers according to the different requirements of the turn on sequence of the servers each time the servers are turned on, so that the servers are turned on according to the aforementioned sequence.

In an optional embodiment, the control board 110 of rack server device includes a storage element 122. The storage element 122 is operable to store a command sequence, and the command sequence is operable to provide the input command.

In operation, the user can directly use the user interface 120 to input the input command so that the user interface 120 sequentially generates the input command respectively. In addition, the user can organize the input command into the command sequence according to the time sequence and store the command sequence in the storage element 122.

In this manner, the control board 110 of rack server device can acquire the input command from the command sequence in the storage element 122 so that the control board 110 of rack server device sequentially outputs the power-on controlling signal to the servers S1-Sn respectively based on the input command, such that the servers S1-Sn are sequentially turned on. In this embodiment, the command sequence may also be formed by the intelligent platform management interface (IPMI) command.

According to the principle and spirit of the present invention, in the method that the control board 110 of rack server device sequentially outputs the power-on controlling signal to the servers S1-Sn respectively based on the input command, after the control board 110 of rack server device outputs the power-on controlling signal to one of the servers S1-Sn for a predetermined period, the control board 110 of rack server device outputs the power-on controlling signal to another one of the servers S1-Sn based on the sequence so as to realize the random power on of the servers S1-Sn.

For example, if the server turn on sequence set by the user is that the server S1 is firstly turned on, the server S2 is then turned on, and thereafter, the server S3 is turned on, after the control board 110 of rack server device outputs the power-on controlling signal to the server S1 for 5 seconds, the control board 110 of rack server device outputs the power-on controlling signal to the server S2. Then, after 5 seconds, the control board 110 of rack server device outputs the power-on controlling signal to the server S3. In this manner, the mechanism of random power on of the servers S1-Sn can be realized, such that the turn on time points of the servers are separated with an appropriate time period, so as to avoid the large power consumption and current rush caused by all the servers turned on at the same time. However, it should not be regarded as the limitation to the present invention, and the user can set the turn on sequence of the servers and the delay time between two servers according to the practical requirements.

Furthermore, the control board 110 of rack server device extracts a media access control address or a rack management address of the baseboard management controller BMC1-BMCn of the servers S1-Sn and randomly generates a plurality of delay periods according to the media access control address or the rack management address, so that the baseboard management controller BMC1-BMCn of the servers S1-Sn sequentially turns on the power of the servers S1-Sn according to the abovementioned delay periods.

According to the above embodiments of the present invention, the application of the present invention has the following advantages. In the embodiments of the present invention, the rack server device is provided to alleviate the problem of large power consumption and current rush caused by turning on the servers in the rack server device at the same time and moderate the load on the power system.

Although the present invention has been disclosed with reference to the above embodiments, these embodiments are not intended to limit the present invention. It will be apparent to those skilled in the art that various modifications and variations can be made without departing from the scope or spirit of the present invention. Therefore, the scope of the present invention shall be defined by the appended claims.

What is claimed is:

1. A rack server device, comprising:
a plurality of servers, each of the servers comprising:
a baseboard management controller for receiving a power-on controlling signal so that the baseboard management controller can turn on the server; and
at least one control board of rack server device connected to the servers through a management network for outputting the power-on controlling signal according to an input command;
wherein the control board of rack server device outputs the power-on controlling signal to the baseboard management controller of one of the servers so that the baseboard management controller turns on the server.

2. The rack server device of claim 1, wherein a power restore state of a basic input/output system (BIOS) of each of the servers is set to be always OFF.

3. The rack server device of claim 1, wherein after the control board of rack server device outputs the power-on controlling signal to the server for a predetermined period, the control board of rack server device outputs the power-on controlling signal to another server to realize a random power on of each of the servers.

4. The rack server device of claim 1, further comprising:
a switch for providing the management network.

5. The rack server device of claim 1, wherein the input command is an intelligent platform management interface (IPMI) command.

6. The rack server device of claim 1, further comprising:
a user interface electrically connected to the device control board of rack server, wherein the input command is generated by the user interface.

7. The rack server device of claim 6, wherein the user interface generates the input command so that the control board of rack server device sequentially outputs the power-on controlling signal to the servers respectively according to the input command, such that the servers are sequentially turned on.

8. The rack server device of claim 1, wherein the control board of rack server device comprises a storage element, the storage element is operable to store a command sequence, and the command sequence is operable to provide the input command.

9. The rack server device of claim 8, wherein the command sequence provides the input command so that the control board of rack server device sequentially outputs the power-on controlling signal to the servers respectively according to the input command, such that the servers are sequentially turned on.

10. The rack server device of claim 8, wherein the command sequence is composed of intelligent platform management interface commands.

11. The rack server device of claim 1, wherein the control board of rack server device extracts a media access control address or a rack management address of the baseboard management controller of the servers and randomly generates a plurality of delay periods according to the media access control address or the rack management address so that the baseboard management controller of the servers sequentially turns on the servers according to the delay periods.
